(19) United States
(12) Patent Application Publication
(10) Pub. No.: US 2009/0220664 A1
(43) Pub. Date: Sep. 3, 2009

(54) METHODS AND APPARATUS FOR THE PRODUCTION OF SWEETENERS

(76) Inventors: Jeffrey L. Tate, North Port, FL (US); James A. Rehkopf, San Rafael, CA (US)

Correspondence Address: CYR & ASSOCIATES, P.A., 605 U.S. Highway 169, Suite 300, Plymouth, MN, 55441, US

(21) Appl. No.: 12/357,336

(22) Filed: Jan. 21, 2009

Related U.S. Application Data
(63) Continuation-in-part of application No. 12/243,435, filed on Oct. 1, 2008.
(60) Provisional application No. 61/011,612, filed on Jan. 18, 2008.

(51) Int. Cl. A23L 1/236

(52) U.S. Cl. 426/548

(57) ABSTRACT

A sweetener in the dried form is described. Methods for drying sweetener in the liquid form into sweetener in the dried form are presented. The methods may include introducing the sweetener in the liquid form into a gas stream and recovering sweetener in the dried form from the gas stream.

### PRIORITY

This application claims the benefit and priority of U.S. Provisional Application No. 61/011,612 filed on Jan. 18, 2008, U.S. patent application Ser. No. 12/215,214, filed on Jun. 25, 2008, and U.S. patent application Ser. No. 12/243,435 filed on Oct. 1, 2008, all of which are incorporated herein by reference in their entireties.

### FIELD OF THE INVENTION

The present inventions relate to sweeteners and, in particular, to methods and apparatus for the production of dried sweeteners.

### BACKGROUND OF THE INVENTION

Trehalose is a disaccharide composed of two glucose molecules bound by an alpha, alpha-1, 1 linkage. Trehalose may be produced from starch by enzymatic cleavage of the starch molecules using the enzymes maltooligosyl trehalose synthase (MTSase) and maltooligosyl trehalose trehalohydrolase (MTHase), which act on amylose or starch to produce trehalose. Trehalose is a generally recognized as safe [GRAS] compound, so that trehalose may be readily used in the food industry, and the particular physical features of trehalose make it an extremely attractive substance for use in the food industry.

Trehalose may be mixed with a high intensity sweetener in water and the resulting mixture dried in order to produce a dry sweetener with a desired sweetness. However, various problems may occur in drying the trehalose—high intensity sweetener mixture. For example, in a crystallization process such as freeze drying, the trehalose crystals tend to exclude the high intensity sweetener. This results in non-uniform distribution of the high intensity sweetener in the dried product. Spray drying of the trehalose-high intensity sweetener mixture may result in at least some thermal degradation of the trehalose and/or the high intensity sweetener. Spray drying as well as freeze drying may also exhibit limited control of particle sizes, densities, morphologies, and flow properties.

Therefore, a need exists for apparatus and methods for the production of dry sweeteners that include trehalose and a high intensity sweetener.

### SUMMARY OF THE INVENTION

Methods and compositions in accordance with the present inventions may resolve many of the needs and shortcomings discussed above and will provide additional improvements and advantages that may be recognized by those of ordinary skill in the art upon review of the present disclosure.

The present inventions may provide methods for producing a sweetener. The methods may include forming a sweetener in a liquid form by combining trehalose with a high intensity sweetener in water, introducing the sweetener in the liquid form into a gas stream, and recovering the sweetener in a dried form from the gas stream. The gas stream may be a pulsed gas stream. In some embodiments the pulsed gas stream has a first temperature, which may be an inlet temperature and a second temperature, which may be an outlet temperature. In some embodiments, the first temperature of the gas stream may range from about 700° F. to about 1300° F., or from about 900° F. to about 1100° F. In these or other embodiments, the second temperature of the gas stream may range from about 150° F. to about 250° F. In some embodiments, the frequency of pulses may range from about 30 to 1000 Hertz.

In these or other embodiments, the method includes a high intensity sweetener comprising aspartame and/or acesulfame potassium. The sweetener in the liquid state may comprise about 50% solids.

The present inventions may provide a sweetener in a dried form. The sweetener may include trehalose and a high intensity sweetener and may have the following properties:
a substantially uniform distribution of trehalose and one or more high intensity sweeteners within the particles,
particle size between about 1 and about 100 microns,
moisture content between about 0.5% and about 10%, and
generally spherical shape.

In some embodiments the particle size is between about 1 and 60 microns. In some embodiments the high intensity sweetener comprises aspartame and/or acesulfame potassium.

Another aspect of the inventions provides a sweetener in dried form, prepared by a process comprising forming a sweetener in a liquid form by combining trehalose with a high intensity sweetener in water, introducing the sweetener in the liquid form into a gas stream; and recovering the sweetener in a dried form from the gas stream. In some embodiments, the first temperature of the gas stream may range from about 700° F. to about 1300° F., or from about 900° F. to about 1100° F. In these or other embodiments, the second temperature of the gas stream may range from about 150° F. to about 250° F. In some embodiments, the frequency of pulses may range from about 30 to 1000 Hertz.

In these or other embodiments, the high intensity sweetener may comprise aspartame and/or acesulfame potassium. The sweetener in the liquid state may comprise about 50% solids.

Other features and advantages of the inventions will become apparent from the following detailed description and from the claims.

### BRIEF DESCRIPTION OF THE FIGURES

FIG. 1 illustrates by schematic diagram an example of the drying of sweetener in the liquid form;

FIG. 2A illustrates by schematic diagram an embodiment of the pulse combustion dryer;

FIG. 2B illustrates by schematic diagram a cross-section of an embodiment of the drying chamber.

All Figures are illustrated for ease of explanation of the basic teachings of the present inventions only; the extensions of the Figures with respect to number, position, order, relationship and dimensions will be explained or will be within the skill of the art after the following description has been read and understood. Further, the apparatus, materials and other operational parameters to conform to specific size, dimension, force, weight, strength, velocity, temperatures, flow and similar requirements will likewise be within the skill of the art after the following description has been read and understood.

Where used to describe the drawings, the terms “top,” “bottom,” “right,” “left,” “forward,” “rear,” “first,” “second,” “inside,” “outside,” and similar terms may be used, the terms should be understood to reference the structure and methods described in the specification and illustrated in the drawings as they generally correspond to their with the apparatus and methods in accordance with the present inventions as will be recognized by those skilled in the art upon review of the present disclosure.

### DETAILED DESCRIPTION OF THE INVENTION

The present inventions provide a composition in the form of a sweetener 73 in a dried form 77 that as well as apparatus and associated methods for use in the production of the sweetener 73 in the dried form 77. The sweetener 73 includes trehalose and one or more high intensity sweeteners. The trehalose and the one or more high intensity sweeteners may be combined generally in the desired proportions in water to form the sweetener 73 in a liquid form 75. The apparatus may include a dryer configured to produce a gas stream 20 to remove the water from the sweetener in order to dry the sweetener 73 in the liquid form 75 into the sweetener 73 in the dried form dried form 77. In one aspect, the water is vaporized by the gas stream 20 to produce the sweetener 73 in the dried form 77. The gas stream 20 may be heated and/or pulsed in various aspects. Methods include drying the sweetener 73 in the liquid form 75 into sweetener 73 in the dried form 77. Surprisingly, the trehalose and high intensity sweetener do not degrade or disintegrate at these high temperatures. The resulting sweetener 73 in the dried form 77 includes trehalose and one or more high intensity sweeteners substantially intermixed generally in the desired proportions. The resulting dried sweetener 77 comprises spherical particles of between about 1 and 100 microns, or between about 0.1 and 300 microns, with a substantially uniform distribution of the two or more sweeteners within the particles. The particles also may be substantially free-flowing and non-aggregating or non-cohesive.

The Figures generally illustrate various exemplary embodiments of apparatus and methods including aspects of the present inventions. The particular exemplary embodiments illustrated in the Figures have been chosen for ease of explanation and understanding of various aspects of the present inventions. These illustrated embodiments are not meant to limit the scope of coverage, but, instead, to assist in understanding the context of the language used in this specification and in the claims. Accordingly, variations of the apparatus, methods, and compositions of matter from the illustrated embodiments may be encompassed by the appended claims.

By certain accepted measures, trehalose has about 45% the sweetness of sucrose. The trehalose may have the α,α-1 linkage between the two glucose moieties. Iso-trehalose (β,β-1 linkage) or neo-trehalose (α, β-1 linkage) may also be used. The sweetener 73 may be formed by adding one or more high intensity sweeteners to the trehalose in proportions such that the resulting sweetener 73 generally matches a desired multiple of the sweetness of sucrose. The sweetness of the sweetener 73 may range from about ½ the sweetness of sucrose to about 12 times the sweetness of sucrose. The high intensity sweeteners added to the trehalose to form the sweetener 73 may include one or more of acesulfame potassium, alitame, aspartame, cyclamate, neohesperidin dihydrochalcone, neotame, saccharin, stevia, sucralose, lohan guo, and similar sweeteners, and combinations thereof, as would be recognized by those of ordinary skill in the art upon review of this disclosure.

In various aspects, trehalose may be combined with the one or more high intensity sweeteners in water to form the sweetener 73 in the liquid form 75. Water, as used herein, may include, for example, water, water in combination with various acids, bases, and buffers, and water in combination with other solvents and additives, and other solvents and/or volatiles. The sweetener 73 may include additional materials such as buffers, acids and bases for the adjustment of the pH, fillers, binding agents, and preservatives. The sweetener 73 in the liquid form 75 may be substantially liquid or may be in the form of slurry, paste, or other viscous or non-Newtonian form. The sweetener 73 in the liquid form 75 may include various agglomerations, aggregations, non-homogeneities, and/or clumps.

The sweetener 73 may be dried from the liquid form 75 to the dried form 77 by contacting the sweetener 73 in the liquid form 75 with a gas stream 20. The sweetener 73 is dried as the sweetener 73 is transported by the gas stream 20. The sweetener 73 in the dried form 77 is drier than, and may be substantially drier than, the sweetener 73 in the liquid form 75. In some aspects, substantially all of the water may be removed from the sweetener 73 in the dried form 77, while, in other aspects, the sweetener 73 in the dried form 77 may retain some residual amount of water. The water content of the sweetener 73 in the dried state 77 may be between 1% and 10% and in some embodiments may be approximately about 6% to about 8%. The sweetener 73 in the liquid form 75 may be continuously introduced into the gas stream 20 and sweetener 73 in the dried form 75 may be continuously recovered from the gas stream 20 over a period of time in a continuous process as opposed to a batch process.

In some aspects, the gas stream 20 may consist generally of air and combustion products produced by the combustion of various solid, liquid, or gaseous fuels or combinations thereof. Examples of fuels would include propane, natural gas, and kerosene. In other aspects, the gas stream 20 may consist of heated air propelled by the release of compression. In various aspects, the gas stream 20 may include other gases or combinations of gases, which may be heated in various ways and configured to form the flowing gas stream 20, as would be recognized by those of ordinary skill in the art upon review of this disclosure.

In some aspects, the gas stream 20 may be characterized by a generally continuous flow. In other aspects, the gas stream 20 may be pulsed, and the pulses may have a frequency that may range from about 30 Hz to about 1,000 Hz. In various aspects, the gas stream 20 may include regions of high velocity flow, turbulence, and may include supersonic flows and shock waves. The gas stream typically has a maximum velocity of between around 10 m/s and 200 m/s and, in certain preferred aspects, is between 50 m/s and 160 m/s but may range upward into the supersonic velocity. When the flow is pulsed, the gas stream 20 may oscillate between a lower value and the maximum velocity as will be recognized by those skilled in the art. When the gas stream is continuous, the maximum velocity may be maintained within a range or at a desired velocity within these ranges. Pressures in the gas stream 20 may be about 2×10⁴ Pa (gage) or more in various aspects. Sound pressures in the gas stream 20 may fall in the range of about 100 dB to about 200 dB in various aspects. In various aspects, a swirl component may be induced into the flow of the gas stream 20.

The flow of the gas stream 20 defines a flow path 90 having a first end 94 and a second end 96 with the gas stream 20 flowing generally from the first end 94 to the second end 96. The first end 94 of the flow path 90 may be generally coincident with the location at which the gas stream 20 is generated. The second end 96 of the flow path 90 may be generally coincident with the region from which the sweetener 73 in the dried form 77 is recovered from the gas stream 20 and may be defined by various structures configured to recover the sweetener 73. The sweetener 73 in the liquid form 75 may be contacted with the gas stream 20 by being introduced into the gas stream 20 at an introduction location 110, with the introduction location 100 disposed along the flow path 90 generally between the first end 94 and the second end 96.

One or more passages 120, which may be defined by tubes, channels, pipes, or other structures, with each passage 120 having one or more passage outlets 122 adapted for the introduction of sweetener 73 into the gas stream 20 may be located in the flow path 90 between the first end 94 and the second end 96, and the location of the passage(s) 120 in the flow path 90 defines the introduction location 110. Sweetener 73 may be introduced into the gas stream 20 at the introduction location 110 through the passage(s) 120. Pumps, piping, valves, and other such structures may be provided in various aspects to convey the sweetener 73 to the passage(s) 120 for introduction into the gas stream 20 at the introduction location 110 as would be recognized by those of ordinary skill in the art upon review of this disclosure.

The temperature of the gas stream 20 may be 2,300° F. or more generally proximate the first end 94 of the gas stream 20, which may be excessive for drying sweetener 73. Accordingly, the temperature of the gas stream 20 may be controlled, in various aspects, to provide a first temperature 104 generally proximate the introduction location 110 and/or a second temperature 106 generally proximate the second end 96 of the flow path 90. The temperature of the gas stream 20 may be controlled in various aspects proximate the first end 94 of the flow path 90 in order to control the first temperature 104 of the gas stream 20 generally proximate the introduction location 110. The temperature of the gas stream 20 may be controlled in various aspects to control the second temperature 106 of the gas stream 20 generally proximate the second end 96 of the flow path 90 where the sweetener 73 in the dried form 77 may be recovered from the gas stream 20.

For example, one or more gas flows may be combined with the gas stream 20 as the gas stream 20 flows along the flow path 90 to control, at least in part, the first temperature 104 of the gas stream 20 at introduction location 110. The one or more gas flows combined with the gas stream 20 may control, at least in part, the temperature at the second end 96 of the flow path 90. The one or more gas flows combined with the gas stream 20 may control, at least in part, the temperature variation of the gas stream 20 between the first temperature 104 and the second temperature 106. In various aspects, one or more gas flows may be combined with the gas stream 20 to provide for the uptake of water vapor and/or for other purposes as would be recognized by those of ordinary skill in the art upon review of this disclosure. In various aspects, conditions at the first end 94 of the flow path 90 may be adjusted in order to achieve a specific first temperature 104 and/or specific second temperature 106.

The first temperature 104 and/or the second temperature 106 may be chosen depending upon the nature of the sweetener 73 to be introduced into the gas stream 20 in order to be dried into the dried form 77. For example, in various aspects, the first temperature 104 may be about 1,000° F. while the second temperature 106 may be about 150° F.

The sweetener 73 may be introduced into the gas stream 20 at the introduction location 110 to be exposed to the temperature of the gas stream 20 while being conveyed by the gas stream 20 from the introduction location 110 to the second end 96 of the flow path 90. The sweetener 73 may be in contact with the gas stream 20 for an exposure time that may be on the order of fractions of a second, and, in some aspects, on the order of a millisecond or less. The temperature of the gas stream 20 may cause water associated with the sweetener 73 to flash into the vapor phase, while the latent heat of vaporization of the water in combination with the exposure time may keep the sweetener 73 generally cool thereby protecting the sweetener 73 from the temperature of gas stream 20. Turbulence, high velocities, and/or shock waves in the gas stream 20 may strip water from the sweetener 73 and may otherwise increase the rate of evaporation of water from the sweetener 73 by various mechanisms. The latent heat of evaporation of the water may also cool the gas stream 20, at least in part, from the first temperature 104 to the second temperature 106, so that the water content of the sweetener 73 in the liquid form 75 may, in some aspects, control the second temperature 106 and may control the temperature variation between the first temperature 104 and the second temperature 106, at least in part. The rate at which sweetener 73 in the liquid form 75 is fed into the gas stream 20 may control the first temperature 94, may control the second temperature 96, and may control the form of the temperature gradient between the first temperature 94 and the second temperature 96 by controlling the rate at which liquid is evaporated.

A collector 60 may be positioned about the second end 96 of the flow path 90 to recover the sweetener 73 generally in the dried form 77 from the gas stream 20, and the collector 60 may generally define the second end 96 of the flow path 90. The collector 60 may be a cyclone, baghouse, screen or series of screens, filter(s), or similar, or combinations thereof configured to capture the sweetener 73 generally in the dried form 77 from the gas stream 20 as would be recognized by those of ordinary skill in the art upon review of this disclosure. The collector 60 may be configured to cooperate with various material handling and storage mechanisms for the manipulation and/or storage of sweetener 73 in the dried form 77, as would be recognized by those of ordinary skill in the art upon review of this disclosure.

In some aspects, the gas stream 20 may be generated by a pulse combustion dryer 30. Examples of pulse combustion dryers 30 are described in U.S. Pat. Nos. 3,462,995, 4,708,159, 4819,873, and 4,941,820 to Lockwood the disclosures of which are hereby incorporated by reference in their entireties. The pulse combustion dryer 30 may include a combustor 31 that defines a combustion chamber 32, and a tailpipe 40 that defines a tailpipe passage 42 having a first tailpipe passage end 44 and a second tailpipe passage end 46. The tailpipe passage 42 is in fluid communication with the combustion chamber 32 through the first tailpipe passage end 44.

The pulse combustion dryer 30, in some aspects, may include a drying chamber 50 that defines a drying chamber passage 52 having a first drying chamber passage end 54, a second drying chamber passage end 56, and centerline 153. The first drying chamber passage end 54 of the drying chamber 50 may be disposed with respect to the second tailpipe passage end 46 of the tailpipe 40 so that the drying chamber passage 52 is in fluid communication with the tailpipe passage 42, and, thence, in fluid communication with the combustion chamber 32. The combustor 31, tailpipe 40, and drying chamber 50 may be disposed with respect to one another in a variety of ways and may assume a variety of orientations with respect to the vertical that would be readily recognized by those of ordinary skill in the art upon review of this disclosure.

Combustion air 86 and fuel 84 may be admitted into the combustion chamber 32, and the resulting fuel-air mixture ignited periodically to provide the gas stream 20 in the form of a series of pulses of air mixed with heated combustion products. Combustion of the fuel-air mixture may be generally complete so that the heated combustion products would consist largely of carbon dioxide and water vapor. The gas stream 20 may flow from the combustion chamber 32 through the tailpipe passage 42 from the first tailpipe passage end 44 to the second tailpipe passage end 46. In aspects that include the drying chamber 50, the gas stream 20 may be communicated from the tailpipe passage 42 into the drying chamber passage 52 generally proximate the first drying chamber passage end 54, and the gas stream 20 may flow through the drying chamber passage 52 generally from the first drying chamber passage end 54 to the second drying chamber passage end 56. Thus, the flow path 90 of the gas stream 20 includes the combustion chamber 32, the tailpipe passage 42, and, in aspects that include drying chamber 50, the flow path 90 also generally includes the drying chamber passage 52. The first end 94 of the flow path 90 may be generally coincident with the combustion chamber 32.

In aspects wherein the gas stream 20 is generated by the pulse combustion dryer 30, the collector 60 may be disposed generally proximate the tailpipe passage second end 96 or, in aspects that include the drying chamber 50, generally proximate the second drying chamber passage end 56 to recover the sweetener 73 in the dried form 77. As would be understood by those of ordinary skill in the art upon review of this disclosure, the collector 60 may be disposed in other ways with respect to the drying chamber 50 to recover the sweetener 73 in the dried form 77 from the second end 96 of the flow path 90 of the gas stream 20.

The sweetener 73 generally in the liquid form 75 may be introduced into the flow path 90 of the gas stream 20 at the introduction location 110. In various aspects, the introduction location 110 may be within the tailpipe passage 42 or within the drying chamber passage 52. The sweetener 73 may be entrained in the gas stream 20 generally at the introduction location 110 and dried while being conveyed by the gas stream 20 along the portion of the flow path 90 from the introduction location 110 to the second end 96 of the flow path 90. The sweetener 73 in the dried form 77 may be recovered at the second end 96 of the flow path 90 of the gas stream 20 by the collector 60.

The sweetener 73 in the liquid form 75 may be introduced into the gas stream 20 at the introduction location 110 from one or more passages 120 through one or more passage outlets 122 defined by the one or more passages 120 disposed about the gas stream 20 at the introduction location 110 for that purpose. The sweetener 73 may pass through the one or more passages 120 into the gas stream 20 by gravity feed and/or by the application of pressures, which may be quite minimal. Pressure pulses in the gas stream 20 may aid in drawing the sweetener 73 through the passage 120 and into the gas stream 20. Accordingly, the shear forces that the sweetener 73 is subjected to while passing through the passage 120 may be generally small or negligible. In various aspects, the rate at which sweetener 73 is fed into the gas stream 20 may be controllable.

In some aspects, nozzles, sprayers, or similar may be appended to the passage 120 to disperse the sweetener 73 from the passage outlet 122 into the gas stream 20. However, this may not be necessary, as the violence of the flow of the gas stream 20 may be sufficient to disperse the sweetener 73 including the dispersal of any agglomerations, aggregations, non-homogeneities and/or clumps of materials. The shock waves and/or turbulence in the gas stream 20 may disperse the sweetener. Sound waves in the gas stream 20 may sonicate the sweetener 73, which may aid in the dispersal of the sweetener 73 into the gas stream 20. Pressure pulses in the gas stream 20 may also aid in the dispersal of the sweetener 73 into the gas stream 20.

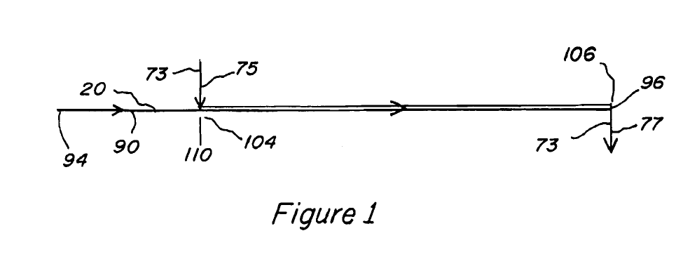

FIG. 1 illustrates by schematic diagram the methods of drying the sweetener 73 in the liquid form 75 into sweetener 73 in the dried form 75 using the gas stream 20. This Figure depicts the gas stream 20 flowing along flow path 90 from the first end 94 to the second end 96. The sweetener 73 in the liquid form 75 is introduced into the gas stream 20 at introduction location 110, as illustrated. The sweetener 73 is dried by the gas stream 20 while being convected by the gas stream 20 from the introduction location 110 to the second end 96 of the flow path 90. The sweetener 73 in the dried form 77 is recovered from the gas stream 20 proximate the second end 96 of the flow path 90, the location or locations at which the sweetener 73 in the dried form 77 is recovered from the gas stream 20 generally defining the second end 94.

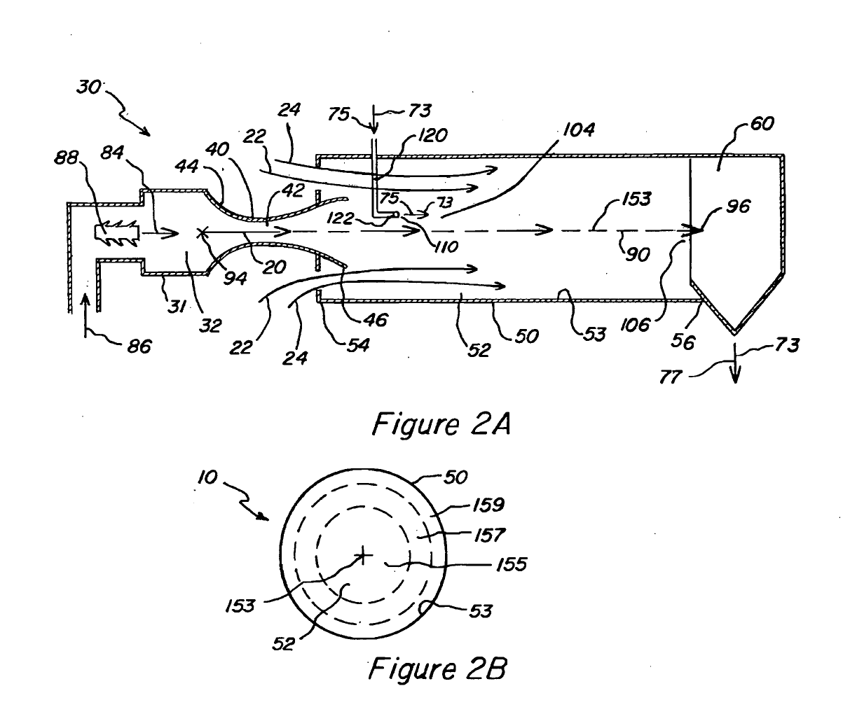

An embodiment of the pulse combustion drier 30 is generally illustrated in FIG. 2A. The embodiment of FIG. 2A includes the combustor 31, the tailpipe 40, and the drying chamber 50. The combustion chamber 31 fluidly communicates with the tailpipe passage 42 through the first tailpipe passage end 44. The tailpipe 40 is disposed with respect to the drying chamber 50 such that the tailpipe passage 42 fluidly communicates through the second tailpipe passage end 46 into the drying chamber passage 52 generally proximate the first drying chamber passage end 54, as illustrated. The drying chamber passage 52 fluidly communicates with the collector 60 through the second drying chamber passage end 56, in this embodiment. In other embodiments, the collector 60 could be otherwise disposed with respect to the drying chamber 50. For example, at least a portion of the collector 60 could be positioned within a portion of the drying chamber passage 52 generally proximate the second drying chamber passage end 56.

In the embodiment illustrated in FIG. 2A, the gas stream 20 is generated within the pulse combustion dryer 30 and the sweetener 73 in the liquid form 75 is introduced into the gas stream 20 to be dried into the sweetener in the dry state 75. Fuel 84 and combustion air 86 are admitted into the combustion chamber 32 defined by the combustor 31 to be ignited periodically in order to produce the gas stream 20. An air valve 88 may be disposed in the path of the combustion air 88 to admit combustion air 88 into the combustion chamber 32 while generally preventing backflows of the gas stream 20, as illustrated. As illustrate in FIG. 2A, the flow of the gas stream 20 from the combustion chamber 32, through the tailpipe passage 42, through the drying chamber passage 52 and into the collector 69 defines the flow path 90. The first end 94 of the flow path 90 is generally within the combustion chamber 32, and the second end 96 of the flow path 90 is generally proximate the collector 60 which is disposed about the second drying chamber passage end 56 of the drying chamber 50 in the embodiment illustrated in FIG. 2A.

Sweetener 73 generally in the liquid form 75 may be introduced into the gas stream 20 at the introduction location 110 through the passage outlet 122 defined by passage 120 in the embodiment illustrated in FIG. 2A. In this embodiment, a portion of the tailpipe 40 extends into the drying chamber passage 52 of the drying chamber 50. The introduction location 110, in this embodiment, is within the drying chamber passage 52 generally proximate the tailpipe passage second end 46 and generally proximate the first drying chamber passage end 54. The passage 120 is disposed within the drying chamber passage 52 to introduce the sweetener into the gas stream 20 generally proximate the centerline 153 of the drying chamber passage 52 in the embodiment of FIG. 2A.

In other embodiments, a plurality of passages 120 may be provided. One or more passages 120 may be disposed within the drying chamber passage 42, in some embodiments, to introduce the sweetener 73 into the gas stream 20 at an off-set from the centerline 153. For example, a plurality of passages 120 may be disposed circumferentially within the drying chamber passage 42 with each passage 120 of the plurality of passages 120 positioned to introduce the sweetener 73 into the gas stream 20 at a constant radial location with respect to the centerline 153.

As illustrated in FIG. 2A, the sweetener 73 may be introduced into the gas stream 20 through the passage outlet(s) 122 to be entrained into the gas stream 20 and dried from the liquid form 75 to the dried form 77. The collector 60 is positioned proximate the second drying chamber passage end 56 and generally defines the second end 96 of the flow path 90, in this illustrated embodiment. The sweetener 73 generally in the dried form 77 may then be recovered from the gas stream 20 by the collector 60.

As illustrated in FIG. 2A, one or more additional airflows may be admitted into the drying chamber passage 52 in various embodiments of the pulse combustion dryer 30. In the embodiment of FIG. 2A, quench air 22 may be admitted into the drying chamber passage 52 generally proximate the first drying chamber end 54 to control the temperature of the gas stream 20 within the drying chamber passage 52. The quantity of quench air 22 admitted into the drying chamber passage 52 may be regulated in order to control the temperature of the gas stream 20 including the first temperature 104 and the second temperature 106. In this embodiment, dilution air 24 may also introduced into the drying chamber passage 52 generally proximate the first drying chamber passage end 54 to provide thermodynamic space for the uptake of water evaporated from the sweetener 73 in order to prevent water condensation and/or saturation conditions in the drying chamber passage 52 and/or in the collector 60. The quantity of dilution air 24 admitted into the drying chamber passage 52 may be regulated in various embodiments.

In the embodiment illustrated in FIG. 2A, the gas stream 20 may pass through a core region 155 generally proximate the centerline 153 of the drying chamber passage 52. The dilution air 24 may pass through the wall region 159 of the drying chamber passage 52 which is the portion of the drying chamber passage 52 generally proximate the inner wall 53 of the drying chamber 50. The quench air 22 may pass through an intermediate region 157 which is intermediate between the wall region 159 and the core region 155.

Sweetener 73 may be introduced into the gas stream 20 passing though the core region 155. The quench air 22 and/or the dilution air 24 may prevent or at least diminish contact between the sweetener 73 and the inner wall 53 of the drying chamber 50 as the sweetener 73 is convected through the drying chamber passage 42 by the gas stream 20 in order to generally reduce or eliminate deposition of sweetener 73 onto the inner wall 53.

FIG. 2B illustrates a cross-section of the drying chamber 50. As illustrated, the drying chamber 50 defines a drying chamber passage 52 having a substantially circular cross-section. In this embodiment, the flows of the gas stream 20, the quench air 22, and the dilution air 24 through the drying chamber passage 52 generally define three regions within the drying chamber passage. These regions include the core region 155 generally proximate the centerline 153 through which the gas stream 20 generally passes, the intermediate region 155 through which the quench air 22 generally passes, and the wall region 159 through which the dilution air 24 generally passes. The pulse combustion dryer 30 may be configured to regulate the amount of quench air 22 and/or the amount of dilution air 24 admitted into the drying chamber passage 52 in order to regulate temperature and other conditions within the drying chamber passage 52. In other embodiments, one or more airstreams could be introduced into the drying chamber passage 52 at various locations about the drying chamber passage 52 to cool the gas stream 20, provide thermodynamic space for evaporation, or for other purposes as would be understood by those of ordinary skill in the art upon review of this disclosure.

The gas stream 20 has a first temperature 104 generally proximate the introduction location 110, as illustrated in FIG. 2A. The gas stream 20 has a second temperature 106 generally proximate the second end 96 of the flow path 90 of the gas stream 20, as illustrated. In various embodiments, the pulse combustion dryer 30 may be configured to regulate the amount of additional gas flows such as the quench air 22 and the dilution air 24 admitted into the gas stream 20 to regulate the temperature. In various embodiments, the fuel admitted into the combustion chamber 32 may be controlled, the pulse rate of the pulse combustion dryer 30 may be regulated, and/or the pulse combustion dryer 30 may be configured and/or controlled in other ways to regulate the temperature of the gas stream 20 including the first temperature 104 and the second temperature 106 as would be recognized by those of ordinary skill in the art upon review of this disclosure.

Methods may include introducing the sweetener 73 in the liquid form 75 into the gas stream 20 and recovering the sweetener 73 in the dried form 77 from the gas stream 20. Various aspects may include continuously introducing the sweetener 73 in the liquid form 75 into the gas stream 20 and continuously recovering the sweetener 73 in the dried form 77 from the gas stream 20 in a continuous process. Some aspects include pulsing the gas stream 20. Some aspects include generating the gas stream 20 using a pulse combustion dryer 30.

The sweetener produced by this process may have a number of distinctive characteristics. The dried particles of the sweetener may be generally spherical in shape with particle sizes between about 1 and 100 microns. The particles may have a substantially uniform distribution of trehalose and one or more high intensity sweeteners within the particles. The moisture content of the dried sweetener may be between about 0.5% and about 10% or between about 0.1% and about 25%. The dried sweetener may also be free-flowing and non-aggregating or non-agglomerating. The generally spherical particles may be relatively smooth compared to particles obtained from spray drying. The dried sweetener particles of this invention may also have a more uniform particle diameter than those obtained by other drying methods such as spray drying, including having a narrower size distribution and lower polydispersity index.

### EXAMPLES

A further understanding may be obtained by reference to certain specific examples, which are provided herein for the purpose of illustration only and are not intended to be limiting unless otherwise specified.

### Example 1

Trehalose and high intensity sweeteners are combined with water according in the proportions given in Table 1 to produce the sweetener in the liquid form. The sweetener may have about 4 times the sweetness of sucrose.

TABLE 1
4 × Sucrose

| | | |
|---|---|---|
| Trehalose | 10.0 | kg |
| Aspartame | 54.0 | g |
| acesulfame | 23.2 | g |
| potassium | | |

Water is added such that the sweetener in the liquid form is approximately 50% solids by weight. The sweetener in the liquid form is dried into the sweetener in the dried form using the pulse combustion dryer Model P-0.1 manufactured by Pulse Combustion Systems, Inc. of Payson, Ariz. A peristaltic pump is used to introduce the sweetener in the liquid form into the drying chamber through a turbo cone nozzle positioned within a ⅜″ venturi. The pulse combustion dryer settings in this example are given in Table 2.

TABLE 2
Pulse Combustion Dryer Settings - Example 1

| | |
|---|---|
| Heat Release | 84,000 ± 1,000 BTUH |
| Turbo Air | 90 ± 5 psi |
| Exhaust Air | 60% |
| Combustion Air | 65% |
| Quench Air | 40% |
| Transportation Air | 5% |
| Contact Temperature | 900° F. |
| Exit Temperature | 200° F. |

The resulting sweetener in the dried form may have the properties given in Table 3.

TABLE 3
Properties Of Sweetener In The Dried form - Example 1

| | |
|---|---|
| mean particle size | 30 μm |
| d₉₀ | 60 μm |
| d₁₀ | 1 μm |

### Example 2

Trehalose and high intensity sweetener are combined with water according in the proportions given in Table 4 to produce the sweetener in the liquid form. The sweetener may have about ½ the sweetness of sucrose.

TABLE 4
0.5 × Sucrose

| Ingredient | Spec. Amount | |
|---|---|---|
| Trehalose | 10.0 | kg |
| Water | 8.18 | kg |
| Aspartame | 0.50 | g |
| acesulfame | 0.25 | g |
| potassium | | |

### Example 3

Trehalose and high intensity sweetener are combined with water according in the proportions given in Table 5 to produce the sweetener in the liquid form. The sweetener may have about the same sweetness as sucrose.

TABLE 5
1 × Sucrose

| Ingredient | Spec. Amount | |
|---|---|---|
| Trehalose | 10.0 | kg |
| Water | 8.18 | kg |
| Aspartame | 13.5 | g |
| acesulfame | 5.8 | g |
| potassium | | |

Water is added such that the sweetener in the liquid form is approximately 33% solids. The sweetener in the liquid form is dried into the sweetener in the dried form using the pulse combustion dryer Model P-0.1 manufactured by Pulse Combustion Systems, Inc. of Payson, Ariz. A peristaltic pump is used to introduce the sweetener in the liquid form into the drying chamber through a turbo cone nozzle positioned within a ⅜″ venturi. The pulse combustion dryer settings in this example are given in Table 6.

TABLE 6
Pulse Combustion Dryer Settings - Example 1

| | |
|---|---|
| Heat Release | 84,000 ± 1,000 BTUH |
| Turbo Air | 90 ± 5 psi |
| Exhaust Air | 60% |
| Combustion Air | 65% |
| Quench Air | 40% |
| Transportation Air | 5% |
| Contact Temperature | 900° F. |
| Exit Temp | 200° F. |

The resulting sweetener in the dried form may have the properties given in Table 7.

TABLE 7
Properties Of Sweetener In The Dried form - Example 1

| | |
|---|---|
| mean particle size | 30 μm |
| d₉₀ | 60 μm |
| d₁₀ | 1 μm |

### Example 4

Trehalose and high intensity sweetener are combined with water according in the proportions given in Table 8 to produce the sweetener in the liquid form. The sweetener may have about 12 times the sweetness of sucrose.

TABLE 8
12 × Sucrose

| Ingredient | Spec. Amount | |
|---|---|---|
| Trehalose | 10.0 | kg |
| Water | 8.18 | kg |
| Aspartame | 162.0 | g |
| acesulfame | 69.6 | g |
| potassium | | |

The foregoing discussion discloses and describes merely exemplary embodiments. Upon review of the specification, one of ordinary skill in the art will readily recognize from such discussion, and from the accompanying figures and claims, that various changes, modifications and variations can be made therein without departing from the spirit and scope of the invention as defined in the following claims.

What is claimed is:

1. A method for producing a sweetener, comprising:
mixing trehalose and a high intensity sweetener in water;
introducing the mixture of the trehelose, the high intensity sweetener and water into a gas stream having a maximum velocity of at least 10 n/s; and
recovering the sweetener in a dried form from the gas stream.

2. The method of claim 1, wherein the gas stream is a pulsed gas stream.

3. The method of claim 2, wherein the mixture of the trehelose, the high intensity sweetener and water is introduced into a portion of the gas stream having a temperature between 700° F. and 1300° F.

4. The method of claim 2, wherein the mixture of the trehelose, the high intensity sweetener and water is introduced into a portion of the gas stream having a temperature between 900° F. and 1100° F.

5. The method of claim 3, further comprising pulsing the gas stream in a frequency of pulses between 30 Hertz and 1000 Hertz.

6. The method of claim 5, wherein a second temperature of the gas stream ranges from about 150° F. to about 250° F.

7. The method of claim 1, wherein the high intensity sweetener comprises aspartame.

8. The method of claim 1, wherein the high intensity sweetener comprises aspartame and acesulfame potassium.

9. The method of claim 1, wherein the trehalose and a high intensity sweetener in water are mixed to about 50% solids.

10. A sweetener in dried form, prepared by the process comprising:
forming a sweetener in a liquid form by combining trehalose with a high intensity sweetener in water;
introducing the sweetener in the liquid form into a gas stream having a maximum velocity of at least 10 m/s; and
recovering the sweetener in a dried form from the gas stream.

11. The sweetener of claim 10, wherein the gas stream is a pulsed gas stream having a first temperature and second temperature.

12. The sweetener of claim 11, wherein the mixture of the trehelose, the high intensity sweetener and water is introduced into a portion of the gas stream having a temperature between 700° F. and 1300° F.

13. The sweetener of claim 11, wherein the mixture of the trehelose, the high intensity sweetener and water is introduced into a portion of the gas stream having a temperature between 900° F. and 1100°

14. The sweetener of claim 11, wherein the frequency of pulses range from about 30 to 1000 Hertz.

15. The sweetener of claim 14, wherein a second temperature of the gas stream ranges from about 150° F. to about 250° F.

16. The sweetener of claim 10, wherein the high intensity sweetener comprises aspartame.

17. The sweetener of claim 10, wherein the high intensity sweetener comprises aspartame and acesulfame potassium.

22. The sweetener of claim 10, wherein the sweetener in the liquid state comprises about 50% solids.
